(19) United States
(12) Patent Application Publication
(10) Pub. No.: US 2024/0014501 A1
(43) Pub. Date: Jan. 11, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Osaka (JP); Osamu NAKAYAMA, Osaka (JP); Mitsutoshi MORITA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/035,191

(22) PCT Filed: Oct. 28, 2021
(86) PCT No.: PCT/JP2021/039817

§ 371 Date: May 3, 2023

(30) Foreign Application Priority Data
Nov. 17, 2020 (JP) 2020-190952

(51) Int. Cl. H01M 50/298; H01M 50/284; H01M 50/507; H01M 50/249; H01M 50/583; H01M 50/519

(52) U.S. Cl. CPC H01M 50/298; H01M 50/284; H01M 50/507; H01M 50/249; H01M 50/583; H01M 50/519; H01M 50/209

(57) ABSTRACT

A wiring module is a wiring module that is attached to a plurality of power storage elements, and includes: a busbar that is connected to electrode terminals of the plurality of power storage elements, an electric wire, and a circuit substrate that connects the busbar and one end of the electric wire, a conductive path is routed on the circuit substrate, and the conductive path includes: a busbar land connected to the busbar, an electric wire land connected to the electric wire, and a fuse portion provided between the busbar land and the electric wire land.

### TECHNICAL FIELD

The present disclosure relates to a wiring module.

### BACKGROUND ART

Usually, in high-voltage battery packs that are used for electric automobiles, hybrid automobiles, and the like, a large number of batteries are stacked, and are electrically connected to each other in series or in parallel by a wiring module. Conventionally, a battery connection module described in JP 2019-23996A (hereinafter, Patent Document 1) is known as such a wiring module. The battery connection module described in Patent Document 1 is constituted by a bus bar and a flexible circuit substrate connected to the bus bar.

### CITATION LIST

### Patent Documents

Patent Document 1: JP 2019-23996A

### SUMMARY OF INVENTION

### Technical Problem

In the above configuration, the flexible circuit substrate includes: a main body that extends in the stacking direction of the batteries, a hole provided at a central portion of the main body and called a “hollow strip”, and an L-shaped flexible arm that has a protruding shape and extends from the main body. Regarding the flexible circuit substrate, commonly, a rectangular substrate called a “standard-size substrate” is punched to form individual pieces, but a small number of long and large flexible circuit substrates that have holes and recesses/protrusions like the above flexible circuit substrate are obtained from the one standard-size substrate, and there is a risk that the manufacturing cost will increase.

### Solution to Problem

A wiring module according to the present disclosure is a wiring module that is attached to a plurality of power storage elements, and includes: a bus bar that is connected to electrode terminals of the plurality of power storage elements, an electric wire, and a circuit substrate that connects the bus bar and one end of the electric wire, a conductive path is routed on the circuit substrate, and the conductive path includes: a busbar land connected to the bus bar, an electric wire land connected to the electric wire, and a fuse portion provided between the busbar land and the electric wire land.

### Advantageous Effects of Invention

According to the present disclosure, it is possible to provide a wiring module whose manufacturing cost can be reduced.

### BRIEF DESCRIPTION OF DRAWINGS

FIG. 1 is a schematic diagram showing a vehicle in which a power storage module according to a first embodiment is mounted.

FIG. 2 is a perspective view of the power storage module.

FIG. 3 is a front view of the power storage module.

FIG. 4 is a perspective view of a power storage element.

FIG. 5 is an enlarged front view of the power storage module, showing circuit substrates.

FIG. 6 is an enlarged front view of the power storage module, showing a second electric wire engagement portion that includes an insulating coating.

FIG. 7 is a cross-sectional view taken along line A-A in FIG. 3.

FIG. 8 is a cross-sectional view taken along line B-B in FIG. 3.

FIG. 9 is a cross-sectional view taken along line C-C in FIG. 5.

FIG. 10 is a cross-sectional view taken along line D-D in FIG. 5.

FIG. 11 is a cross-sectional view taken along line E-E in FIG. 5.

FIG. 12 is a cross-sectional view taken along line F-F in FIG. 5.

FIG. 13 is a cross-sectional view taken along line G-G in FIG. 5.

FIG. 14 is a schematic diagram showing circuit substrates obtained by punching a standard-size substrate.

FIG. 15 is a schematic diagram showing T-shaped circuit substrates obtained by punching a standard-size substrate.

FIG. 16 is an enlarged front view of a power storage module, showing a circuit substrate according to a second embodiment.

FIG. 17 is an enlarged front view of a power storage module, showing a circuit substrate according to a third embodiment.

FIG. 18 is an enlarged front view of a power storage module, showing a circuit substrate according to a fourth embodiment.

FIG. 19 is a cross-sectional view taken along line H-H in FIG. 18.

FIG. 20 is a perspective view of a power storage module according to a fifth embodiment.

FIG. 21 is an enlarged plan view of a power storage module, showing circuit substrates.

### EMBODIMENTS OF THE INVENTION

### Description of Embodiments of Disclosure

First, embodiments of the present disclosure will be listed and described.

(1) A wiring module according to the present disclosure is a wiring module that is attached to a plurality of power storage elements, and includes: a bus bar that is connected to electrode terminals of the plurality of power storage elements, an electric wire, and a circuit substrate that connects the bus bar and one end of the electric wire, a conductive path is routed on the circuit substrate, and the conductive path includes: a busbar land connected to the bus bar, an electric wire land connected to the electric wire, and a fuse portion provided between the busbar land and the electric wire land.

With such a configuration, the wiring module is provided with the electric wire in addition to the circuit substrate, and thus, compared with a case where no electric wire is provided, it is possible to reduce the usage amount of the circuit substrate, and optimize the shape of the circuit substrate. Therefore, it is possible to reduce the manufacturing cost of the wiring module.

(2) Preferably, a protector that holds the bus bar, the circuit substrate, and the electric wire is provided, and the protector includes an electric wire engaging portion that engages with the electric wire.

With such a configuration, the electric wire can be engaged with the protector.

(3) Preferably, two electric wire engaging portions are provided for the one electric wire land, and are disposed on two sides of the electric wire land.

With such a configuration, it is easy to electrically connect the electric wire and the electric wire land to each other.

(4) Preferably, the circuit substrate includes an engagement portion, and the protector includes a substrate engaging portion that engages with the engagement portion.

With such a configuration, the circuit substrate can be engaged with the protector.

(5) Preferably, a connector that is connected to the other end of the electric wire is provided, and the connector is held by the protector.

With such a configuration, electrical signals from the plurality of power storage elements can be transmitted to the outside by the connector.

(6) Preferably, the fuse portion includes a chip fuse, and a connection portion between the chip fuse and the conductive path is covered with an insulating resin.

With such a configuration, even in an environment where water droplets or the like are formed on the circuit substrate due to condensation, short-circuiting of the conductive path can be suppressed.

(7) Preferably, the circuit substrate is a flexible printed substrate, and the fuse portion is constituted by a pattern fuse.

With such a configuration, the fuse portion can be formed in a process of manufacturing the flexible printed substrate.

(8) Preferably, a plurality of busbar lands, electric wire lands, and fuse portions are provided on at least one circuit substrate.

With such a configuration, it is possible to reduce the number of circuit substrates used for the wiring module, and thus it is possible to improve the ease of assembly of the wiring module.

(9) The wiring module is a wiring module that is attached to a front side and a rear side of the plurality of power storage elements elongated in a front-rear direction, and may include the electric wire that is routed so as to extend in the front-rear direction.

With such a configuration, the wiring module includes the electric wire routed so as to extend in the front-rear direction, and thus it is possible to reduce the manufacturing cost of the wiring module.

(10) The wiring module is a vehicle wiring module that is mounted and used in a vehicle.

### DETAILED DESCRIPTION OF EMBODIMENTS OF DISCLOSURE

Embodiments of the present disclosure will be described below. The present disclosure is not limited to illustrations of these, but is indicated by the claims, and all changes that come within the meaning and range of equivalency of the claims are intended to be embraced therein.

### First Embodiment

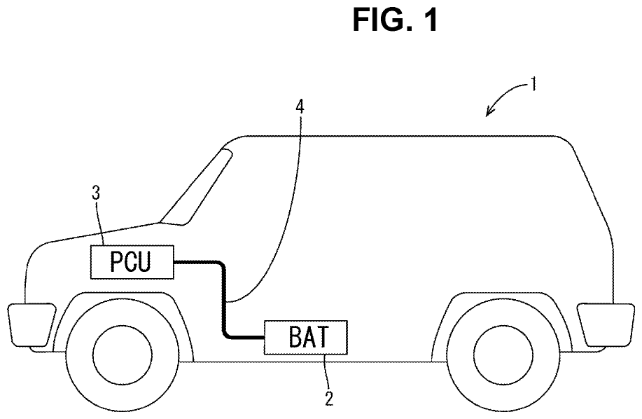

A first embodiment of the present disclosure will be described with reference to FIGS. 1 to 15. A power storage module 10 that includes wiring modules 20 according to the present embodiment is applied to a power storage pack 2 mounted in a vehicle 1 as shown in FIG. 1, for example. The power storage pack 2 is mounted in the vehicle 1 that is an electric automobile, a hybrid automobile, or the like, and is used as a driving source of the vehicle 1. In the following description, only some of a plurality of identical members are given reference numerals, and reference numerals for the other members may be omitted.

As shown in FIG. 1, the power storage pack 2 is disposed in the vicinity of the center of the vehicle 1. A PCU (Power Control Unit) 3 is disposed on the front side of the vehicle 1. The power storage pack 2 and the PCU 3 are connected by a wire harness 4. The power storage pack 2 and the wire harness 4 are connected to each other by a connector (now shown). The power storage pack 2 includes the power storage module 10 that includes a plurality of power storage elements 11. The power storage module 10 (and the wiring modules 20) can be mounted in any orientation, but, hereinafter, except for FIGS. 1, 14, and 15, description will be given assuming that the Z arrow indicates the upward direction, the X arrow indicates the forward direction, and the Y arrow indicates the left direction.

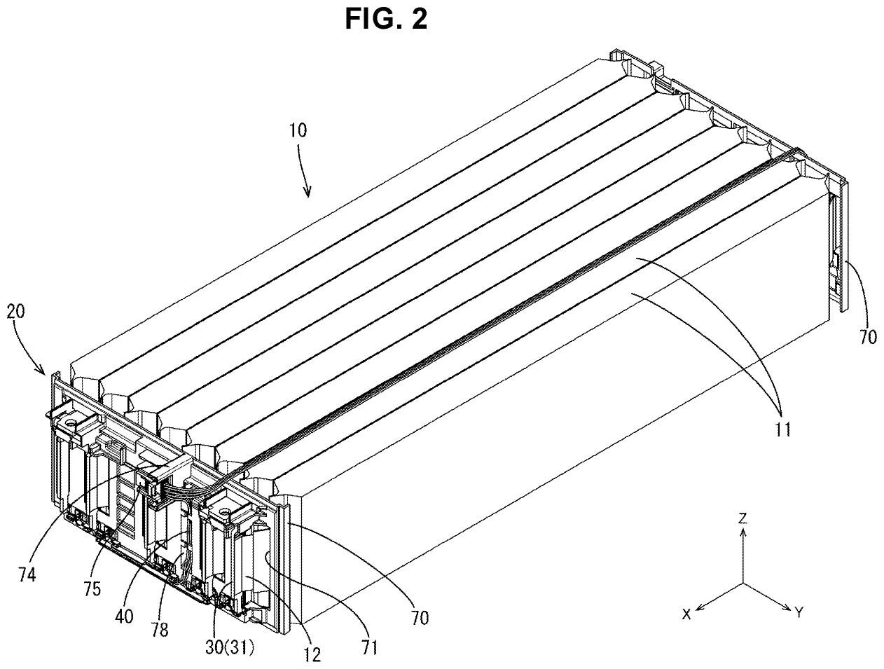

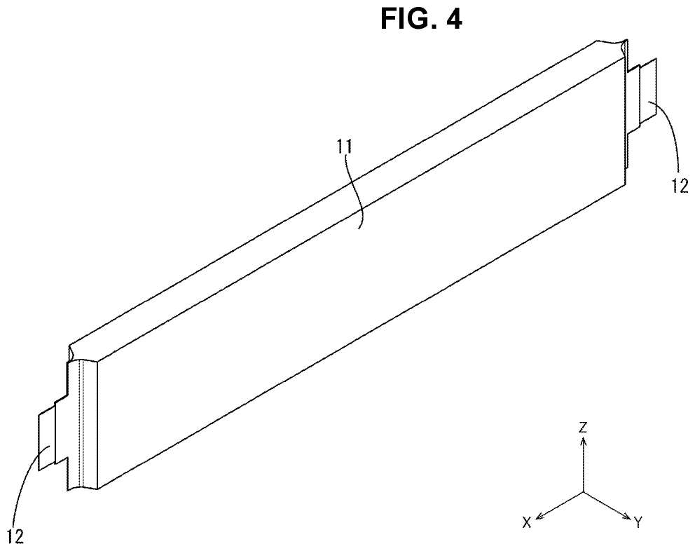

As shown in FIG. 2, the power storage module 10 includes the plurality of power storage elements 11 arranged in the left-right direction, and the wiring modules 20 respectively attached to the front side and the rear side of the plurality of power storage elements 11. As shown in FIG. 4, each power storage element 11 has a shape elongated in the front-rear direction and flat in the left-right direction. The power storage element 11 houses a power storage component (not shown). A pair of electrode terminals 12 are disposed on the two sides in the front-rear direction of the power storage element 11, and protrude so as to face directions opposite to each other. The pair of electrode terminals 12 have a plate-like shape, and have opposite polarities.

### Wiring Module

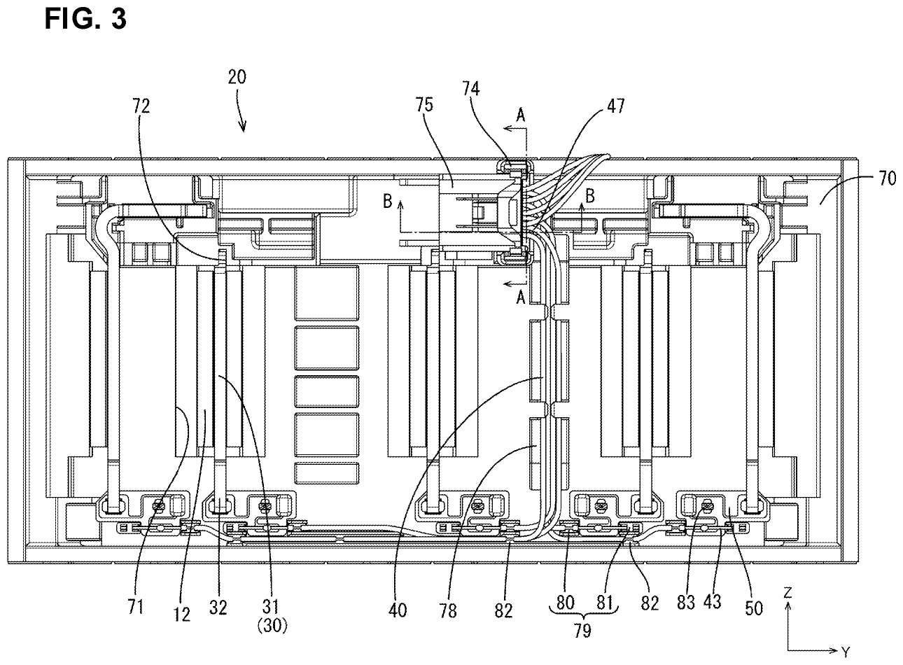

As shown in FIG. 3, the wiring module 20 according to the present embodiment includes busbars 30 that are connected to the electrode terminals 12, electric wires 40, circuit substrates 50 that connect the busbars 30 to ends 43 on one side of the electric wires 40, respectively, and a protector 70 that holds the busbars 30, the electric wires 40, and the circuit substrates 50. As shown in FIG. 2, the wiring modules 20 are attached to the front side and the rear side of the plurality of power storage elements 11. A configuration of the wiring module 20 that is disposed on the front side of the plurality of power storage elements 11 will be described below in detail, and a redundant description of a configuration of the wiring module 20 that is disposed on the rear side of the plurality of power storage elements 11 is omitted.

### Protector

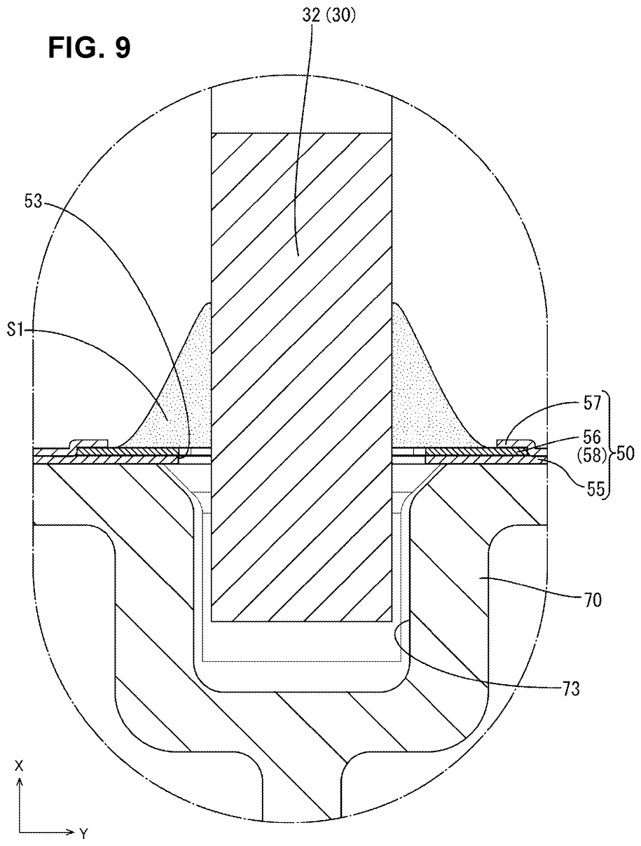

As shown in FIG. 2, the wiring modules 20 according to the present embodiment are respectively provided with protectors 70 disposed on the front side and the rear side of the plurality of power storage elements 11. Each protector 70 is made of an insulating synthetic resin, and is shaped like a plate. As shown in FIG. 3, electrode receiving portions 71 are provided at central portions in the up-down direction of the protector 70, in parallel in the left-right direction. The electrode receiving portions 71 are formed to extend through the protector 70 in the front-rear direction, and are shaped as a vertically elongated rectangle. Groove portions 72 that hold the busbars 30 are provided on the upper side of each protector 70. Positioning holes 73 for receiving leading ends of busbar-side connection portions 32 of the busbars 30 are provided on the lower side of each protector 70 as shown in FIG. 9.

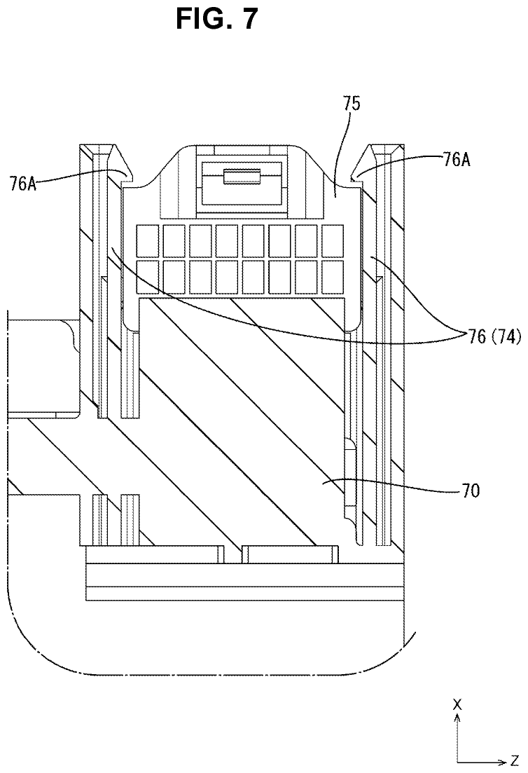

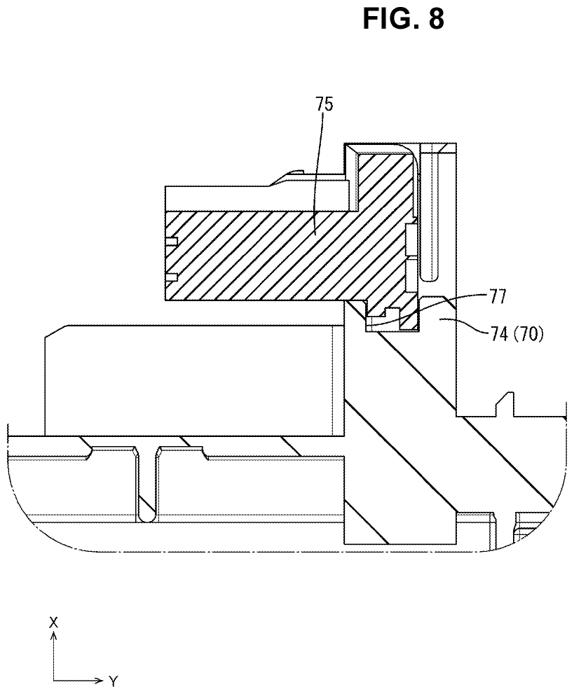

As shown in FIGS. 2 and 3, a connector holding portion 74 that protrudes forward is provided at a central position in the left-right direction, on the upper side of the protector 70. The connector holding portion 74 is a member for holding a connector 75 to be described later, and is provided only on the protector 70 disposed on the front side of the plurality of power storage elements 11. As shown in FIG. 7, the connector holding portion 74 includes a pair of flexible pieces 76 that can deflect and deform in the up-down direction, and connector engaging portions 76A provided respectively on the flexible pieces 76. As shown in FIG. 8, the connector holding portion 74 further includes a connector-mounting recessed portion 77 for mounting the connector 75.

### Electric Wire Engaging Portion

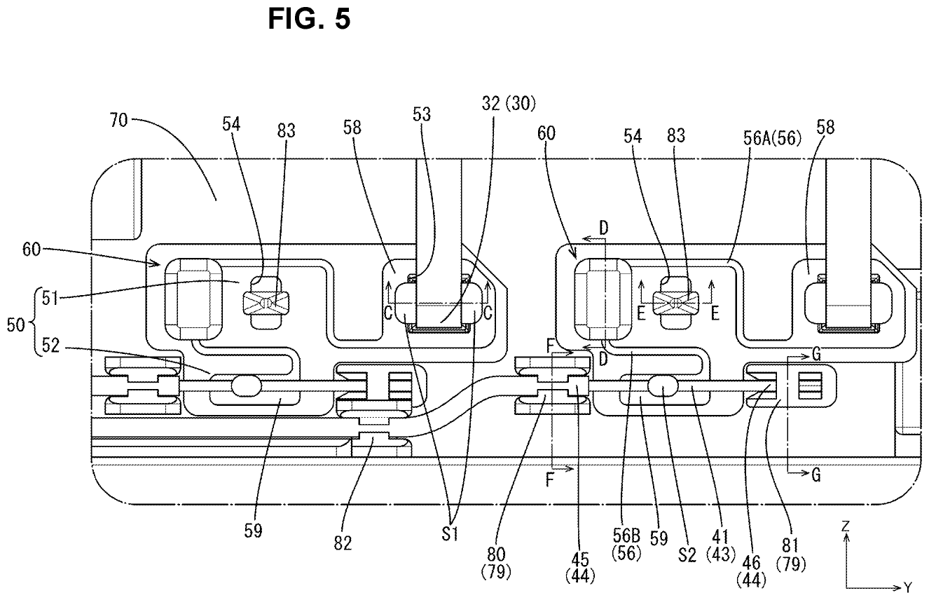

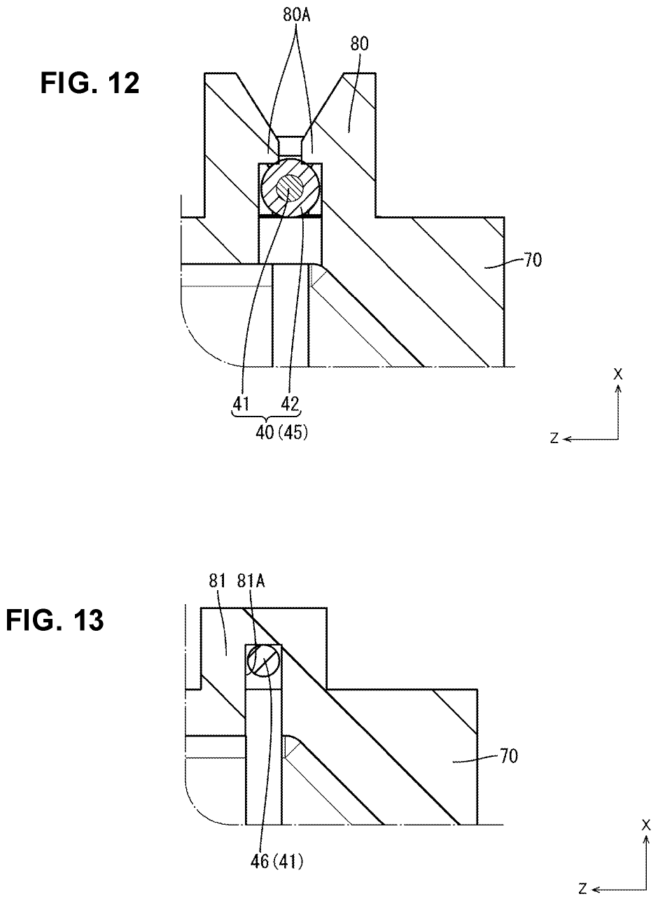

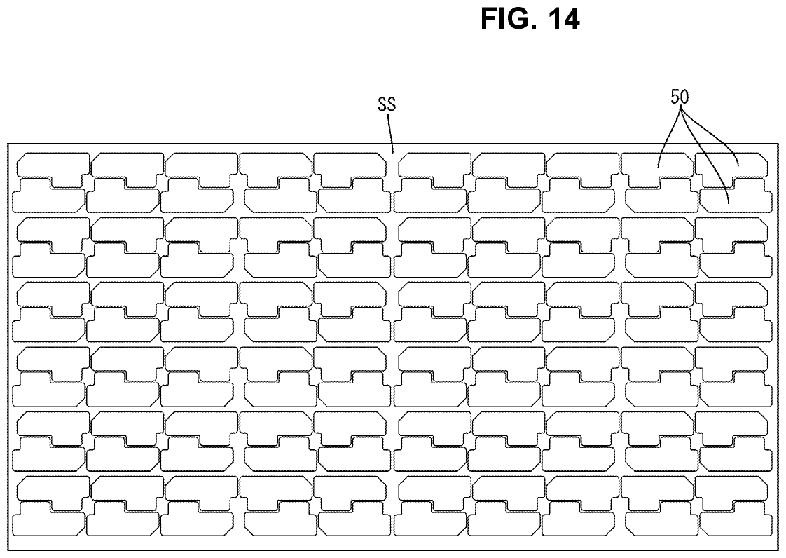

As shown in FIG. 3, a routing recessed portion 78 extending in the up-down direction is provided slightly on the left side (right side of the figure) relative to the central position in the left-right direction of the protector 70. The routing recessed portion 78 is formed so as to be recessed toward the plurality of power storage elements 11 (see FIG. 2), and is configured to be able to collectively route a plurality of electric wires 40 in the up-down direction. Below the routing recessed portion 78, electric wire engaging portions 79 for respectively engaging electric wires 40 are provided in parallel in the left-right direction. As shown in FIG. 5, two electric wire engaging portions 79 are provided for one electric wire land 59 of the circuit substrate 50 to be described later, and are disposed on two sides in the left-right direction of the electric wire land 59. One of the electric wire engaging portions 79 positioned on the two sides of the electric wire land 59 is referred to as a “first electric wire engaging portion 80”, and the other is referred to as a “second electric wire engaging portion 81”. As shown in FIG. 12, the first electric wire engaging portion 80 includes a pair of engaging claw portions 80A opposing each other in the up-down direction. As shown in FIG. 13, the second electric wire engaging portion 81 includes an insertion hole 81A formed to extend therethrough in the left-right direction (the perpendicular direction of the figure).

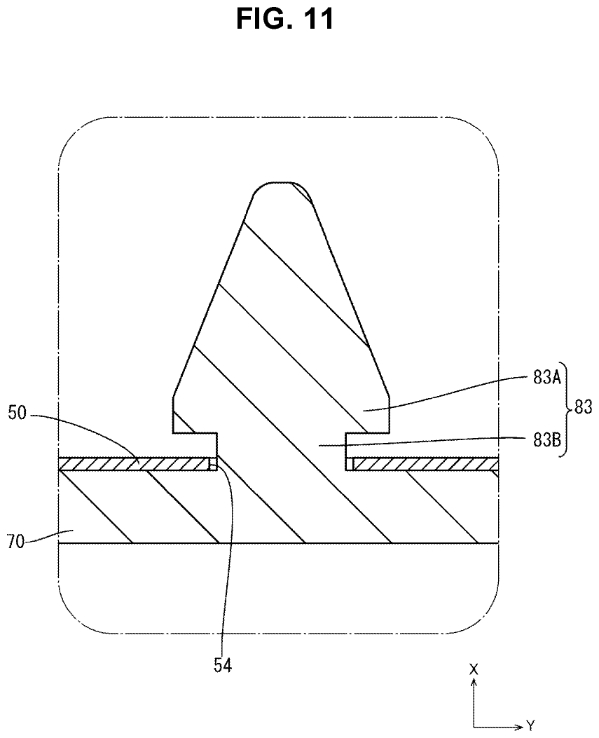

As shown in FIG. 3, below the electric wire engaging portions 79, routing engaging portions 82 provided for routing the electric wires 40 are provided in parallel in the left-right direction. The routing engaging portions 82 are shaped similarly to the first electric wire engaging portion 80. As shown in FIG. 5, above an intermediate position between the first electric wire engaging portion 80 and the second electric wire engaging portion 81, a substrate engaging portion 83 protruding forward is provided. As shown in FIG. 11, the substrate engaging portion 83 is formed in the shape of a protrusion, and the outer diameter of an umbrella portion 83A on the leading end side thereof is larger than a shaft portion 83B on the base end side.

### Busbar

Each of the busbars 30 is shaped as a plate, and is formed by processing a conductive metal plate. As shown in FIG. 3, the busbar 30 is held by a groove portion 72 provided on the upper side of the protector 70 such that the plate thickness direction thereof matches the left-right direction. A central portion of the busbar 30 serves as a busbar main body portion 31 to which the electrode terminals 12 are connected. The busbar-side connection portion 32 is provided on the lower side of the busbar 30. As shown in FIG. 9, the busbar-side connection portion 32 is inserted into a connection hole 53 of the circuit substrate 50, and is soldered to a busbar land 58 (which will be described in detail later). A leading end of the busbar-side connection portion 32 inserted into the connection hole 53 is received by the positioning hole 73, and the busbar 30 is positioned relative to the protector 70.

As shown in FIG. 2, when the wiring modules 20 are attached to the front side and the rear side of the plurality of power storage elements 11, the electrode terminals 12 are inserted into the electrode receiving portions 71 of the protectors 70, and are folded as appropriate so as to abut against the busbar main body portions 31, and the electrode terminals 12 and the busbar main body portions 31 are then connected to each other through laser welding.

### Circuit Substrate and Engaging Holes

As shown in FIG. 5, the circuit substrate 50 includes a rectangular main body portion 51 and a protrusion portion 52 that protrudes downward from the main body portion 51. The main body portion 51 is provided with the connection hole 53 into which the busbar-side connection portion 32 of the busbar 30 is inserted, and an engaging hole 54 into which the substrate engaging portion 83 of the protector 70 is inserted. Here, the inner wall of the engaging hole 54 is an example of an engagement portion. That is to say, a configuration is adopted in which the inner wall of the engaging hole 54 and the substrate engaging portion 83 are engaged with each other, and thus the circuit substrate 50 is attached to the protector 70. The connection hole 53 is disposed at a position near an outer edge of the main body portion 51, and the engaging hole 54 is disposed at a central portion of the main body portion 51. The same number of circuit substrates 50 according to the present embodiment as the number of busbars 30 are provided.

### Conductive Path

The circuit substrate 50 according to the present embodiment is a flexible printed substrate that has flexibility, and includes a base film 55, a conductive path 56 routed on the surface of the base film 55, and a coverlay film 57 that covers the conductive path 56, as shown in FIG. 9. The base film 55 and the coverlay film 57 are made of an insulating and flexible synthetic resin such as polyimide. The conductive path 56 is made of a metal foil of copper, a copper alloy, or the like. As shown in FIG. 5, the conductive path 56 includes the busbar land 58 connected to the busbar 30, the electric wire land 59 connected to the electric wire 40, and a fuse portion 60 provided between the busbar land 58 and the electric wire land 59.

### Busbar Land and Electric Wire Land

As shown in FIGS. 5 and 9, each busbar land 58 is formed near the connection hole 53, and is disposed at one end of the conductive path 56. The busbar land 58 is electrically connected to the busbar-side connection portion 32 of the busbar 30 inserted into the connection hole 53, using solder 51. As shown in FIG. 5, the electric wire land 59 is formed at a central portion of the protrusion portion 52, and is disposed at the other end of the conductive path 56. The electric wire land 59 is electrically connected to a core wire 41 of the electric wire 40 disposed extending over the protrusion portion 52 in the left-right direction, using solder S2.

### Fuse Portion, Chip Fuse, and Insulating Resin

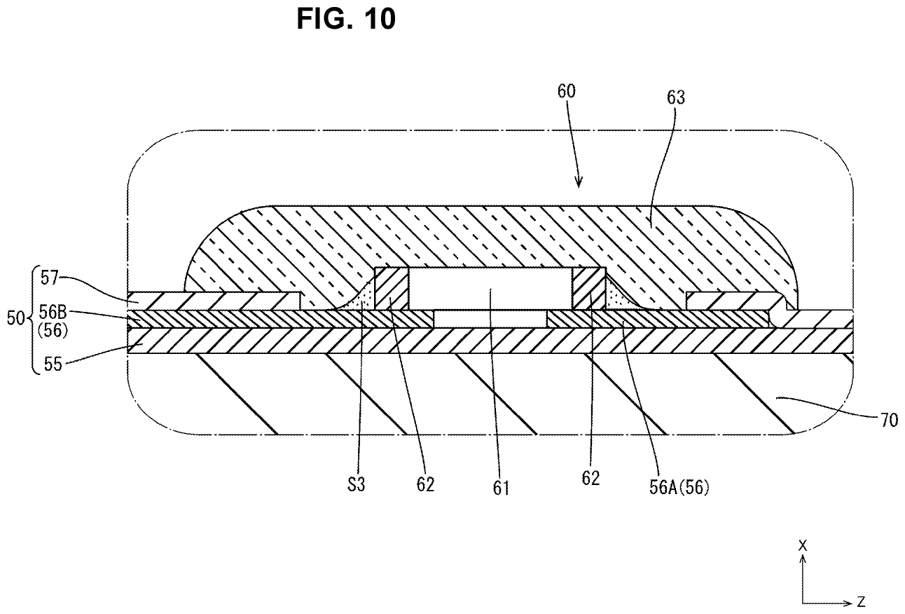

As shown in FIG. 5, the fuse portion 60 is provided at an intermediate portion of the conductive path 56 that extends from the busbar land 58 to the electric wire land 59. As shown in FIG. 10, the fuse portion 60 according to the present embodiment includes a chip fuse 61, and the chip fuse 61 and the conductive path 56 are connected using solder S3. Specifically, one of a pair of electrodes 62 of the chip fuse 61 is connected to a conductive path 56A on the busbar land 58 side, and the other is connected to a conductive path 56B on the electric wire land 59 side (see FIG. 5). A connection portion between the chip fuse 61 and the conductive path 56 is covered with an insulating resin 63. Here, the connection portion between the chip fuse 61 and the conductive path 56 includes at least the entire chip fuse 61, the solder S3, and an end portion of the conductive path 56 that is connected to the electrodes 62 of the chip fuse 61, and is not covered by the coverlay film 57.

Even when a failure occurs in an external circuit connected to the power storage module 10, and short-circuiting occurs between conductive paths 56, causing an overcurrent, it is possible to restrict the flow of the overcurrent from a power storage element 11 to the conductive path 56 by providing the fuse portion 60. In addition, the insulating resin 63 covers the connection portion between the chip fuse 61 and the conductive path 56, and thus, even when water droplets or the like are formed on the circuit substrate 50 due to condensation, it is possible to suppress short-circuiting of the conductive path 56.

### Electric Wire, One End of Electric Wire, and Other End of Electric Wire

As shown in FIG. 12, the electric wire 40 includes the core wire 41 and an insulating coating 42 that covers the core wire 41. As shown in FIG. 3, the end portion of the electric wire 40 disposed on the lower side of the protector 70 is one end 43 of the electric wire 40. The end portion on the opposite side to the one end 43 of the electric wire 40 is another end 47 of the electric wire 40, and is connected to the connector 75. As shown in FIG. 5, the one end 43 of the electric wire 40 is connected to the electric wire land 59 of the circuit substrate 50. At the one end 43 of the electric wire 40, on two sides of the core wire 41 that is connected to the electric wire land 59, electric wire engagement portions 44 that are respectively engaged with the electric wire engaging portions 79 of the protector 70 are provided. One of the electric wire engagement portions 44 that is disposed on the other end 47 side of the electric wire 40 (in other words, on the connector 75 side) is referred to as a “first electric wire engagement portion 45”, and the other is referred to as a “second electric wire engagement portion 46”. As shown in FIG. 12, the first electric wire engagement portion 45 is engaged with the engaging claw portion 80A of the first electric wire engaging portion 80. The first electric wire engagement portion 45 includes the insulating coating 42, and thus the core wire 41 of the first electric wire engagement portion 45 is kept from being damaged by the engaging claw portion 80A. Accordingly, electrical connection between the connector 75 and the busbar land 58 is kept from being damaged.

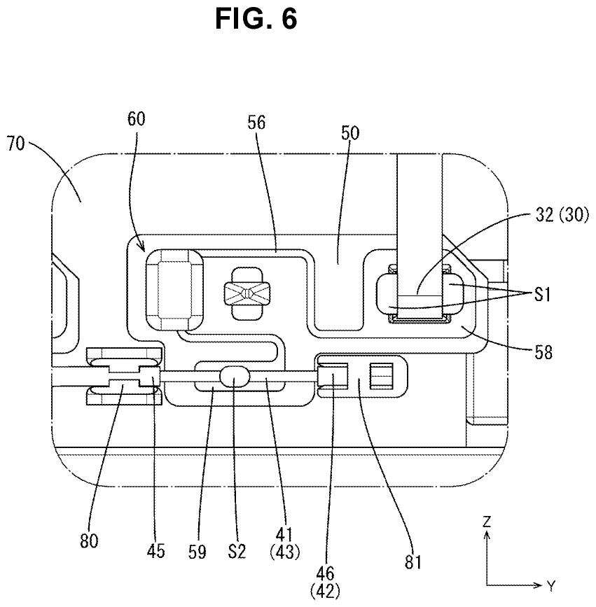

The second electric wire engagement portion 46 can be formed by only the core wire 41 as shown in FIG. 13, and is inserted into the insertion hole 81A of the second electric wire engaging portion 81, thereby being engaged therewith. If the core wire 41 is formed by a plurality of strands, the core wire 41 of the second electric wire engagement portion 46 is preferably coated with solder or the like. Accordingly, the strands do not separate from each other and spread apart, and thus it is easy to engage the second electric wire engagement portion 46 with the second electric wire engaging portion 81. In addition, as shown in FIG. 6, even if a configuration is adopted in which the second electric wire engagement portion 46 includes the insulating coating 42, similar effects are achieved.

As shown in FIG. 3, each electric wire 40 is routed at a predetermined position of the protector 70 using the routing recessed portion 78 and the routing engaging portion 82. Accordingly, connection between the one end 43 of the electric wire 40 and the circuit substrate 50 is less likely to be interfered with by another electric wire 40.

As shown in FIGS. 2 and 3, a portion of the electric wire 40 drawn out from the connector 75 is routed rearward on the upper surface of the plurality of power storage elements 11, and is connected to the circuit substrate 50 disposed on the rear side of the plurality of power storage elements 11, in a similar manner to the above configuration. In this manner, in the present embodiment, the wiring modules 20 that are attached to the front and the rear of the plurality of power storage elements 11 are formed by routing the long electric wires 40 in the front-rear direction, and thus, for example, compared with a case where a similar wiring module is formed by circuit substrates without using electric wires, it is possible to reduce the manufacturing cost of the wiring module 20.

### Connector

The connector 75 is made of an insulating synthetic resin, and is shaped as a block as shown in FIG. 2. As shown in FIG. 8, the connector 75 is mounted to the connector-mounting recessed portion 77 so as not to move in the left-right direction. As shown in FIG. 7, the connector 75 is held by the protector 70 by being engaged with the connector engaging portions 76A from above. The connector 75 is configured to house a female terminal (not shown). As shown in FIG. 3, the electric wire 40 connected to the female terminal is drawn out from the left side of the connector 75. A partner connector (not shown) that includes a male terminal is fitted into the female terminal from the right side of the connector 75. The partner connector is connected to an external ECU (Electronic Control Unit) or the like via an electric wire (not shown). The ECU is equipped with a microcomputer, an element, and the like, and has a known configuration that includes functions of detecting a voltage, a current, a temperature, and the like of each of the power storage elements 11, and performing charging/discharging control and the like of the power storage elements 11.

### Number of Obtained Circuit Substrates

In the present embodiment, as shown in FIG. 5, each circuit substrate 50 is formed with the minimum necessary size for forming the busbar land 58, the fuse portion 60, and the electric wire land 59. In addition, as shown in FIG. 3, an inexpensive electric wire 40 is used as a conductor that is routed on the protector 70, and connects the connector 75 and the circuit substrate 50. With such a configuration, it is possible to reduce the usage amount of the circuit substrate 50 by the wiring module 20 while favorably realizing electrical connection of the busbar 30 and formation of the fuse portion 60 using the circuit substrate 50. In addition, with such a configuration, the circuit substrate 50 is compact and shaped with less recesses and protrusions, and thus, as shown in FIG. 14, it is possible to reduce waste from a standard-size substrate SS, and form a large number of circuit substrates 50 (only outlines thereof are shown). That is to say, it is possible to increase the number of circuit substrates 50 that can be obtained from one standard-size substrate SS. Therefore, it is possible to reduce the manufacturing cost of the wiring module 20.

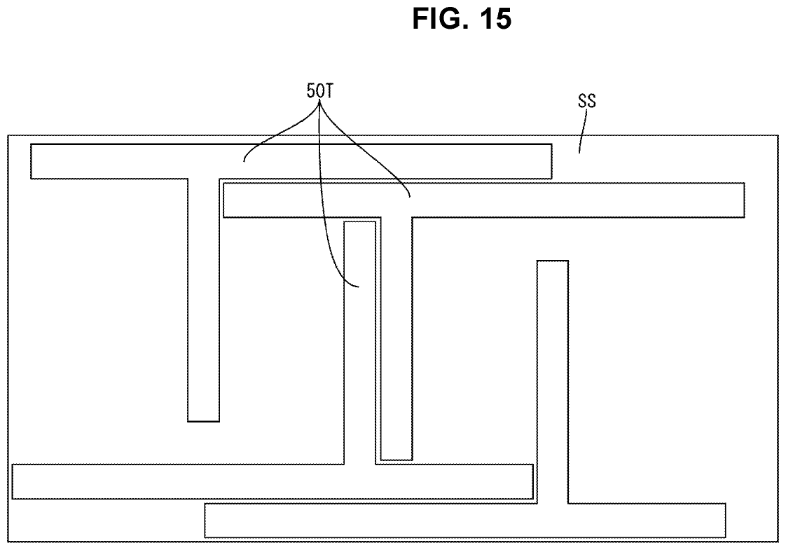

On the other hand, if a case is assumed where a similar wiring module is manufactured without using the electric wires 40 used in the present embodiment, there is a need to form T-shaped circuit substrates 50T (only the outlines thereof are shown) as shown in FIG. 15. Note that, here, for simplification, consideration is given to only a circuit substrate disposed on the front side of the plurality of power storage elements 11. When forming T-shaped circuit substrates 50T from the standard-size substrate SS, a large portion of the standard-size substrate SS is wasted, and the number of T-shaped circuit substrates 50T that can be obtained from the one standard-size substrate SS is very small. Thus, the manufacturing cost of the wiring module is increased.

The present embodiment has the above-described configuration, and an example of assembly of the wiring module 20 will be described below.

First, the circuit substrate 50 provided with the fuse portion 60 in advance is attached to the protector 70. The umbrella portion 83A of the substrate engaging portion 83 is inserted into the engaging hole 54 of the circuit substrate 50, and the circuit substrate 50 is thus pivotally supported by the shaft portion 83B (see FIG. 11). The protrusion portion 52 is disposed between the electric wire engaging portions 79, and the connection hole 53 is aligned with the positioning hole 73, thereby disposing the circuit substrate 50 at a predetermined position of the protector 70 (see FIG. 5). A flexible printed substrate that has flexibility is adopted as the circuit substrate 50, and thus the circuit substrate 50 can be easily attached to the protector 70.

The busbar 30 is attached to the protector 70. While inserting an upper portion of the busbar 30 into the groove portion 72 (see FIG. 3), a busbar connection portion 32 is inserted into the connection hole 53 of the circuit substrate 50, and is inserted into the positioning hole 73 of the protector 70 (see FIG. 9). Next, the busbar connection portion 32 and the busbar land 58 are soldered to each other.

Next, the connector 75 connected to the electric wire 40 is attached to the connector holding portion 74 of the protector 70. When a left portion of the connector 75 is pressed against the connector holding portion 74 rearward from above, the flexible pieces 76 deflect, and the connector 75 is housed in the connector mounting recessed portion 77, and is engaged with the connector engaging portions 76A from above (see FIGS. 7 and 8). The electric wire 40 is then routed at a predetermined position of the protector 70 (see FIG. 3). Lastly, the electric wire engagement portion 44 of the electric wire 40 is engaged with the electric wire engaging portion 79, and the core wire 41 is soldered to the busbar land 58, thereby completing assembly of the wiring module 20 (see FIG. 5).

Note that it is also conceivable that a process of routing the electric wires 40 on the protector 70 and a process of soldering the electric wires 40 to the busbar lands 58 are performed after the protectors 70 are attached to the front and rear of the plurality of power storage elements 11 and the electrode terminals 12 and the busbars 30 are connected to each other. This is because, when, for example, the power storage elements 11 are very long, there are cases where the wiring module 20 cannot be easily handled once assembly is complete.

### Operations and Effects of First Embodiment

According to the first embodiment, the following operations and effects are achieved.

The wiring module 20 according to the first embodiment is the wiring module 20 that is attached to the plurality of power storage elements 11, and includes: the busbars 30 that are connected to the electrode terminals 12 of the plurality of power storage elements 11, the electric wires 40, and the circuit substrates 50 that connect the busbars 30 and the ends 43 on one side of the electric wires 40 to each other, the conductive path 56 is routed on each of the circuit substrates 50, and includes: the busbar land 58 connected to the busbar 30, the electric wire land 59 connected to the electric wire 40, and the fuse portion 60 provided between the busbar land 58 and the electric wire land 59.

With the above configuration, in addition to the circuit substrates 50, the electric wires 40 are provided in the wiring module 20, and thus, compared with a case where no electric wires 40 are provided, it is possible to reduce the usage amount of the circuit substrates 50, and optimize the shape of the circuit substrates 50. Therefore, it is possible to reduce the manufacturing cost of the wiring module 20.

In the first embodiment, the protector 70 for holding the busbar 30, the circuit substrate 50, and the electric wire 40 is provided, and the protector 70 includes the electric wire engaging portions 79 for engaging with the electric wire 40.

With the above configuration, the electric wire 40 can be engaged with the protector 70.

In the first embodiment, two electric wire engaging portions 79 are provided for each electric wire land 59, and are respectively disposed on two sides of the electric wire land 59.

With the above configuration, it is easy to electrically connect the electric wire 40 and the electric wire land 59 to each other.

In the first embodiment, the circuit substrate 50 includes the engaging hole 54, and the protector 70 includes the substrate engaging portion 83 that engages with the inner wall of the engaging hole 54.

With the above configuration, the circuit substrate 50 can be engaged with the protector 70.

In the first embodiment, the connector 75 that is connected to the other end 47 of the electric wire 40 is provided, and the connector 75 is held by the protector 70.

With the above configuration, electrical signals from the plurality of power storage elements 11 can be transmitted the outside using the connector 75.

In the first embodiment, the fuse portion 60 includes the chip fuse 61, and the connection portion between the chip fuse 61 and the conductive path 56 is covered with the insulating resin 63.

With the above configuration, even in an environment where water droplets or the like are formed on the circuit substrate 50 due to condensation, it is possible to suppress short-circuiting of the conductive path 56.

The wiring module 20 according to the first embodiment is the wiring module 20 that is attached on each of the front side and the rear side of the plurality of power storage elements 11 that are elongated in the front-rear direction, and includes the electric wires 40 that are routed so as to extend in the front-rear direction.

With the above configuration, the wiring module 20 includes the electric wires 40 that are routed so as to extend in the front-rear direction, and thus it is possible to reduce the manufacturing cost of the wiring module 20.

### Second Embodiment

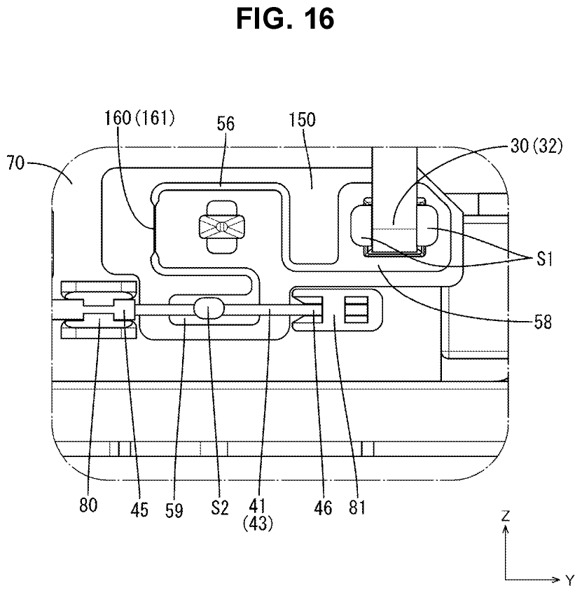

A second embodiment of the present disclosure will be described with reference to FIG. 16. Configurations according to the second embodiment are the same as those according to the first embodiment except for a fuse portion 160. Hereinafter, the same members as those in the first embodiment are given the reference numerals as used in the first embodiment, and a description of the same configurations, and operations and effects as the first embodiment is omitted.

As shown in FIG. 16, a circuit substrate 150 according to the second embodiment includes the fuse portion 160. The fuse portion 160 is formed by a pattern fuse 161 provided by forming the conductive path 56 in a thin shape. The circuit substrate 150 is a flexible printed substrate that has a thin film. Accordingly, heat generated when an overcurrent flows through the pattern fuse 161 is less likely to escape, and the pattern fuse 161 is fused. Therefore, it is possible to restrict the flow of an overcurrent through the conductive path 56.

In the first embodiment, a process of connecting the chip fuse 60 to an end portion of the conductive path 56 is required to form the fuse portion 60. However, in the present embodiment, in a manufacturing process of a normal flexible substrate, the pattern fuse 161 (the fuse portion 160) can be formed when forming the conductive path 56, and the circuit substrate 150 can be manufactured efficiently.

### Operations and Effects of Second Embodiment

According to the second embodiment, the following operations and effects are achieved.

In the second embodiment, the circuit substrate 150 is a flexible printed substrate, and the fuse portion 160 is formed by the pattern fuse 161.

With the above configuration, the fuse portion 160 can be formed in a manufacturing step of a flexible printed substrate.

### Third Embodiment

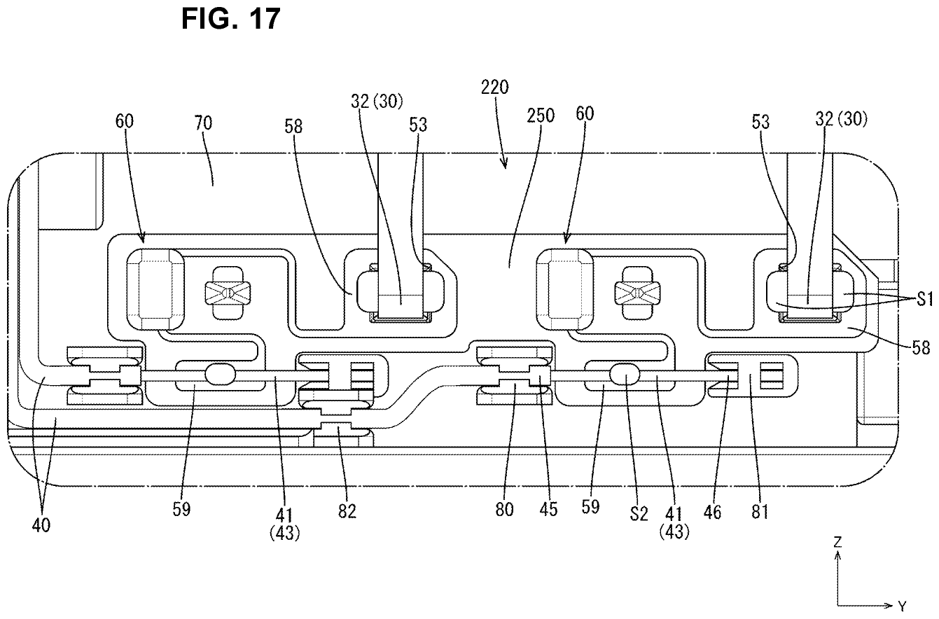

A third embodiment of the present disclosure will be described with reference to FIG. 17. Configurations according to the third embodiment are the same as those according to the first embodiment except that a circuit substrate 250 is included. Hereinafter, the same members as those in the first embodiment are given the reference numerals as used in the first embodiment, and a description of the same configurations, and operations and effects as the first embodiment is omitted.

As shown in FIG. 17, a wiring module 220 according to the third embodiment includes the circuit substrate 250. The circuit substrate 250 has a configuration in which two circuit substrates 50 according to the first embodiment (see FIG. 5) are combined. That is to say, the circuit substrate 250 includes two connection holes 53, two busbar lands 58, two electric wire lands 59, and two fuse portions 60, and is connected to two busbars 30 and two electric wires 40. Here, particularly the circuit substrate 250 formed by combining two circuit substrates 50 is described, but it is also possible to adopt a circuit substrate formed by combining three or more circuit substrates 50 in accordance with arrangement, sizes, manufacturing costs, and the like of members of the wiring module 220.

### Operations and Effects of Third Embodiment

According to the third embodiment, the following operations and effects are achieved.

According to the third embodiment, at least one circuit substrate 250 is provided with a plurality of busbar lands 58, a plurality of electric wire lands 59, and a plurality of fuse portions 60.

With the above configuration, it is possible to reduce the number of circuit substrates 250 that are used for the wiring module 220, and thus it is possible to improve the ease of assembly of the wiring module 220.

### Fourth Embodiment

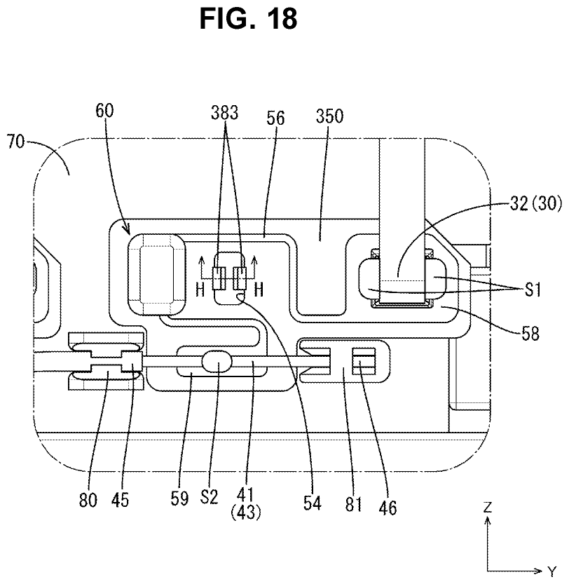

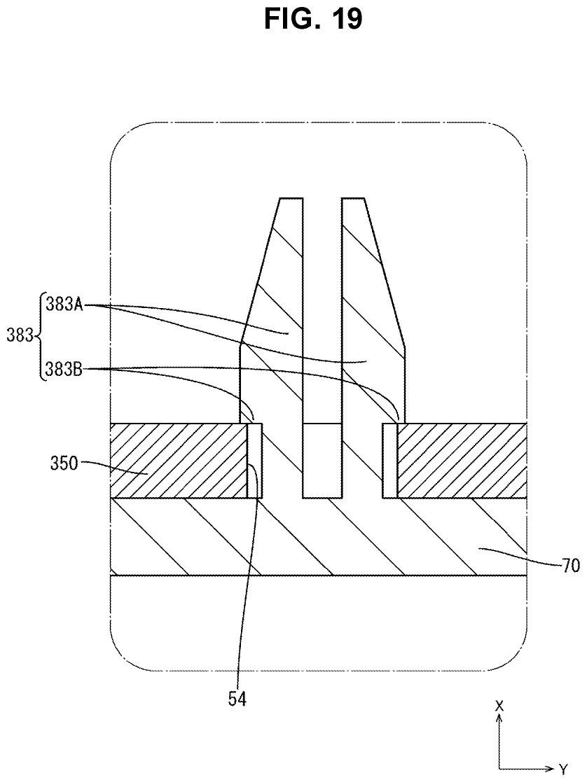

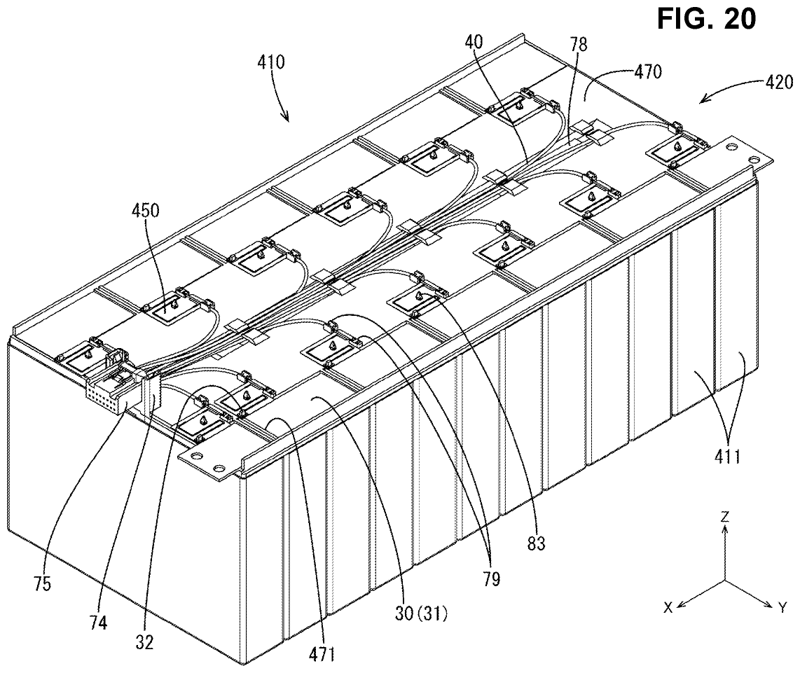

A fourth embodiment of the present disclosure will be described with reference to FIGS. 18 and 19. Configurations according to the fourth embodiment are the same as those according to the first embodiment except for a circuit substrate 350 and a substrate engaging portion 383. Hereinafter, the same members as those in the first embodiment are given the reference numerals as used in the first embodiment, and a description of the same configurations, operations, and effects as the first embodiment is omitted.

The circuit substrate 350 according to the fourth embodiment is a hard printed substrate. As shown in FIG. 18, the circuit substrate 350 is held by the protector 70 using substrate engaging portions 383. As shown in FIG. 19, each substrate engaging portion 383 is constituted by a pair of substrate engaging pieces 383A that are elastically deformable in the left-right direction, and a pair of substrate engaging claw portions 383B. With such a configuration, by pressing the engaging hole 54 of the circuit substrate 350 against the substrate engaging portions 383, the substrate engaging pieces 383A deflect and deform, and are inserted into the engaging hole 54, and the circuit substrate 350 can be engaged with the protector 70 using the substrate engaging claw portions 383B.

A hard printed substrate can be manufactured at a lower cost than a flexible printed substrate. In addition, a hard printed substrate is harder than and has a more stable shape than a flexible printed substrate, and thus has the advantage of being easy to handle.

### Fifth Embodiment

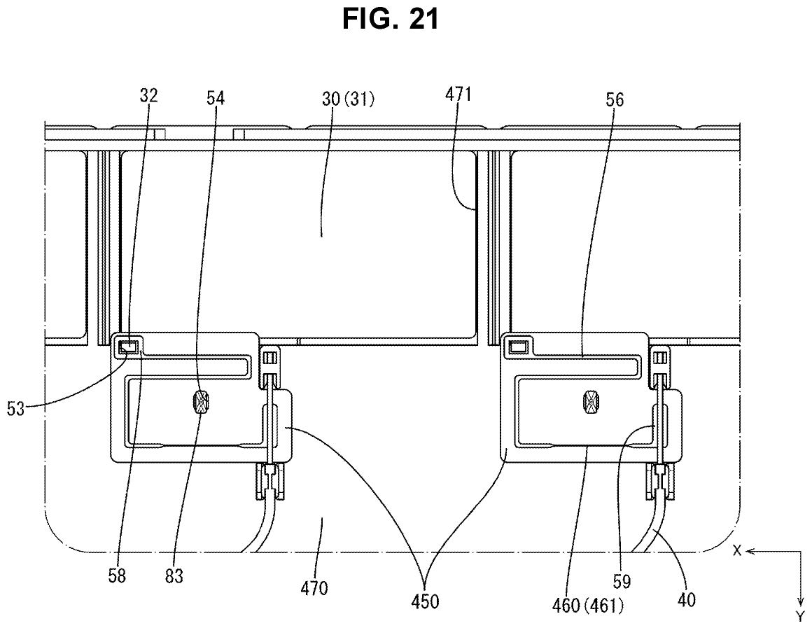

A fifth embodiment of the present disclosure will be described with reference to FIGS. 20 and 21. Hereinafter, members similar to those according to the first embodiment are given the reference numerals used in the first embodiment, and a description of configurations, operations, and effects that are similar to those in the first embodiment is omitted.

As shown in FIG. 20, a power storage module 410 according to the fifth embodiment includes a plurality of power storage elements 411 arranged in a row, and a wiring module 420 that is attached to the upper surface of the plurality of power storage elements 411. The power storage elements 411 are each shaped as a flat rectangular parallelepiped that houses a power storage component (not shown). A pair of electrode terminals (not shown) are respectively provided at the right end and the left end of the upper surface of each power storage element 411. The wiring module 420 includes busbars 30 each have a plate shape, electric wires 40, circuit substrates 450, and a protector 470.

As shown in FIG. 20, one protector 470 is provided for one wiring module 420, and similarly to the first embodiment, includes the connector holding portion 74 for holding the connector 75, the routing recessed portion 78, the electric wire engaging portions 79, the substrate engaging portions 83, and the like. The protector 470 includes busbar storage portions 471 that house the busbars 30. Positioning of the busbars 30 is performed by the busbar storage portions 471, and thus the positioning holes 73 according to the first embodiment are not provided in the protector 470.

As shown in FIG. 20, the busbars 30 each have a plate shape, and are housed in the busbar storage portions 471 such that the plate thickness direction thereof matches the up-down direction. The busbars 30 are disposed on the upper surface of the plurality of power storage elements 411, and connect electrode terminals adjacent in the front-rear direction to each other. The busbar-side connection portions 32 of the busbars 30 protrude upward relative to the busbar main body portions 31.

As shown in FIG. 21, the circuit substrate 450 is provided similarly to the circuit substrate 150 according to the second embodiment, and includes a fuse portion 460 formed by a pattern fuse 461. The busbar-side connection portion 32 is inserted into the connection hole 53 of the circuit substrate 450 upward from below. The busbar land 58 and the busbar connection portion 32 are electrically connected to each other using solder (now shown), and the electric wire land 59 and the electric wire 40 are electrically connected to each other using solder (not shown).

As shown in FIG. 20, in the fifth embodiment, the wiring module 420 is configured to be attached to one surface of the plurality of power storage elements 411, but the number of power storage elements 411 constituting the power storage module 410 is large, and thus the size of the wiring module 420 in the stacking direction (front-rear direction) is increased. Therefore, it is possible to reduce the manufacturing cost of the wiring module 420 by forming the wiring module 420 using the electric wires 40 and the circuit substrates 450.

### Other Embodiments

(1) In the above embodiments, the circuit substrates 50, 150, 250, and 450 are flexible printed substrates, and the circuit substrate 350 is a hard printed substrate, but there is no limitation thereto, and various circuit substrates can be adopted.
(2) In the above embodiments, a configuration is adopted in which the protectors 70 or 470 are provided, but there is no limitation thereto, and a configuration may also be adopted in which no protector is provided.
(3) In the above embodiments, a configuration is adopted in which the electric wire engaging portions 79 include the first electric wire engaging portion 80 and the second electric wire engaging portion 81, but there is no limitation thereto, and a configuration in which electric wire engaging portions include only first electric wire engaging portions, or a configuration in which electric wire engaging portions include only second electric wire engaging portions may also be adopted.
(4) In the above embodiments, the substrate engaging portions 83 and 383 engage with the inner walls of the engaging holes 54, but there is no limitation thereto, and, for example, a configuration may also be adopted in which a substrate engaging portion shaped as a claw engages with an outer edge portion of a circuit substrate.
(5) In the first, third, and fourth embodiments, a configuration is adopted in which the connection portion between the chip fuse 61 and the conductive path 56 is covered with the insulating resin 63, but there is no limitation thereto, and a configuration may also be adopted in which a chip fuse is not covered with an insulating resin.
(6) In the above embodiments, a configuration is adopted in which the circuit substrates 50, 150, 250, and 450 are engaged with the substrate engaging portions 83, and the circuit substrate 350 is engaged with the substrate engaging portions 383, but there is no limitation thereto, and a configuration may also be adopted in which a circuit substrate is held by a protector using heat caulking, an adhesive, or the like.
(7) In the above embodiments, a configuration is adopted in which the busbar-side connection portion 32 is inserted into the connection hole 53, and is connected to the busbar land 58, but there is no limitation thereto, and a configuration may also be adopted in which a circuit substrate does not include a connection hole.

### LIST OF REFERENCE NUMERALS

1 Vehicle
2 Power storage pack
3 PCU
4 Wire harness
10, 410 Power storage module
11, 411 Power storage element
12 Electrode terminal
220, 420 Wiring module
30 Busbar
31 Busbar main body portion
32 Busbar-side connection portion
40 Electric wire
41 Core wire
42 Insulating coating
43 One end of electric wire
44 Electric wire engagement portion
45 First electric wire engagement portion
46 Second electric wire engagement portion
47 Other end of electric wire
150, 250, 350, 450 Circuit substrate
50T T-shaped circuit substrate
51 Main body portion
52 Protrusion portion
53 Connection hole
54 Engaging hole
55 Base film
56 Conductive path
57 Coverlay film
58 Busbar land
59 Electric wire land
60, 160, 460 Fuse portion
61 Chip fuse
62 Electrode
63 Insulating resin
70, 470 Protector
71 Electrode receiving portion
72 Groove portion
73 Positioning hole
74 Connector holding portion
75 Connector
76 Flexible piece
76A Connector engaging portion
77 Connector-mounting recessed portion
78 Routing recessed portion
79 Electric wire engaging portion
80 First electric wire engaging portion
80A Engaging claw portion
81 Second electric wire engaging portion
81A Insertion hole
82 Routing engaging portion
83, 383 Substrate engaging portion
83A Umbrella portion
83B Shaft portion
161, 461 Pattern fuse
383A Substrate engaging piece
383B Substrate engaging claw portion
471 Busbar storage portion
S1, S2, S3 Solder
SS Standard-size substrate

1. A wiring module that is attached to a plurality of power storage elements, comprising:
a bus bar that is connected to electrode terminals of the plurality of power storage elements;
an electric wire; and
a circuit substrate that connects the bus bar and one end of the electric wire,
wherein a conductive path is routed on the circuit substrate, and
the conductive path includes: a busbar land connected to the bus bar, an electric wire land connected to the electric wire, and a fuse portion provided between the busbar land and the electric wire land.

2. The wiring module according to claim 1, further comprising
a protector that holds the bus bar, the circuit substrate, and the electric wire,
wherein the protector includes an electric wire engaging portion that engages with the electric wire.

3. The wiring module according to claim 2,
wherein two electric wire engaging portions are provided for the one electric wire land, and are disposed on two sides of the electric wire land.

4. The wiring module according to claim 2,
wherein the circuit substrate includes an engagement portion, and
the protector includes a substrate engaging portion that engages with the engagement portion.

5. The wiring module according to claim 2, further comprising
a connector that is connected to the other end of the electric wire,
wherein the connector is held by the protector.

6. The wiring module according to claim 1,
wherein the fuse portion includes a chip fuse, and
a connection portion between the chip fuse and the conductive path is covered with an insulating resin.

7. The wiring module according to claim 1,
wherein the circuit substrate is a flexible printed substrate, and
the fuse portion is formed by a pattern fuse.

8. The wiring module according to claim 1,
wherein a plurality of busbar lands, electric wire lands, and fuse portions are provided on at least one circuit substrate.

9. The wiring module according to claim 1,
wherein the wiring module is a wiring module that is attached to a front side and a rear side of the plurality of power storage elements elongated in a front-rear direction,
and includes the electric wire that is routed so as to extend in the front-rear direction.

10. The wiring module according to claim 1,
wherein the wiring module is a vehicle wiring module that is mounted and used in a vehicle.
